(19) United States
(12) Patent Application Publication
(10) Pub. No.: US 2026/0330984 A1
(43) Pub. Date: Oct. 22, 2026

(54) DETECTING AND AVOIDING OBSTACLES IN DYNAMIC ENVIRONMENTS

(71) Applicant: Honeywell International Inc., Charlotte, NC (US)

(72) Inventors: Kiran Perikala, Hyderabad (IN); Tulasi Naraharisetty, Hyderabad (IN)

(21) Appl. No.: 19/249,589

(22) Filed: Jun. 25, 2025

(30) Foreign Application Priority Data
Apr. 17, 2025 (IN) 202511037285

(51) Int. Cl. G08G 5/80; G08G 5/26; G08G 5/34; G08G 5/57; G08G 5/59

(52) U.S. Cl. CPC G08G 5/80; G08G 5/26; G08G 5/34; G08G 5/57; G08G 5/59

(57) ABSTRACT

Certain aspects of the disclosure pertain to flight plans for unmanned aircraft operating in dynamic environments. A polygon region can be created for an area defined by source and destination coordinates, enabling targeted data retrieval from multiple databases through data slicing. Multiple candidate flight plans can be generated, and the most suitable flight plan can be selected based on the data obtained. An initial flight plan directing the unmanned aircraft's flight can be selected from a plurality of candidate flight plans generated from the data. During flight, the unmanned aircraft can continuously monitor information from onboard sensors for unexpected obstacles. If a detected obstacle is avoidable, a flight plan system can generate an updated flight plan that maneuvers around the obstacle while maintaining the original flight path. For an unavoidable obstacle, an alternative flight plan is developed from the current location to the destination that reroutes around the obstacle.

This application claims the benefit of Indian Provisional Patent Application No. 202511037285, filed Apr. 17, 2025, the entire contents of which are incorporated herein by reference.

### TECHNICAL FIELD

Aspects of the subject disclosure relate to aviation technology, including unmanned aircraft and the detection and avoidance of obstacles.

### BACKGROUND

Unmanned aerial vehicles (UAVs) are increasingly prevalent in a wide range of industries, offering capabilities such as aerial surveillance, package delivery, environmental monitoring, and emergency response. Rapid advancements in UAV technology have significantly enhanced their operational efficiency and effectiveness, making UAVs an asset to both commercial and public service industries.

One advantage of UAVs is their ability to operate in diverse environments, ranging from urban landscapes with complex infrastructure to rural terrains with natural obstacles, such as forests, mountains, and bodies of water, which present navigational challenges. To address these challenges, UAVs are equipped with collision avoidance technology that exploits onboard sensors, including LiDAR, ultrasonic sensors, and high-resolution cameras. These sensors can continuously collect data, which can be analyzed to detect obstacles in a UAV's flight path and enable the UAV to respond to its environment.

However, collision avoidance technologies can rely on manual intervention to take control of a UAV when an obstacle is detected. Dependence on human intervention can introduce delays in response time and reduce the autonomy of UAV operations, especially when split-second decisions are required, such as in search and rescue operations that involve navigating hazardous environments.

### SUMMARY

The following summary provides a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

Briefly described, various methods, apparatuses, and systems related to improving obstacle detection and avoidance in dynamic environments are disclosed. In one instance, a computing device can generate an initial flight plan for an unmanned aircraft. The computing device can further determine a polygon region, including a set of vertices and edges that connect the set of vertices that encompass source and destination coordinates. The polygon region enables slicing data sources, enabling targeted data retrieval from multiple data sources based on a region or area. Utilizing data from sliced data sources, a computing device can generate multiple candidate flight plans that start at the source and end at the destination. The computing device can further analyze the candidate flight plans and determine the best-suited flight plan based on one or more factors, such as flight time, flight distance, and weather conditions, among other things. During flight, the computing device can continuously monitor the environment for unexpected obstacles, generate a reformulated flight plan to address an unexpected obstacle, and transmit the reformulated flight plan to the unmanned aircraft to replace the current flight plan. In accordance with one aspect, the reformulated flight plan can correspond to an updated current flight plan that performs one or more evasive maneuvers to bypass an avoidable obstacle. In another aspect, the reformulated flight plan can be an alternate flight plan that reroutes around an unavoidable obstacle. Moreover, generating an updated or alternate flight plan can involve utilizing advanced analytics with respect to onboard sensor data and data from multiple data sources to perform collision avoidance automatically.

Certain aspects provide a method for creating a flight plan. The method comprises obtaining a first request for a flight plan for an unmanned aerial vehicle from a source to a destination, generating a polygon capturing a region comprising the source and destination, wherein the polygon comprises a set of vertices including latitude and longitude of the source and destination and connecting edges, fetching data from one or more databases that relate to the region of the polygon, generating a plurality of flight plans from the source to the destination, and identifying a select flight plan from the plurality of flight plans based on the data fetched from the one or more databases, and transmitting the select flight plan to the unmanned aerial vehicle. Furthermore, the method can comprise obtaining a signal during the flight of the unmanned aircraft indicating the detection of an unexpected obstacle associated with the flight plan, determining a reformulated flight plan with a different flight path that addresses the unexpected obstacle, and transmitting the reformulated flight plan to the unmanned aircraft.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

To the accomplishment of the foregoing and related ends, certain illustrative aspects of the claimed subject matter are described herein in connection with the following description and annexed drawings. These aspects are indicative of several ways in which the subject matter may be practiced, all of which are intended to be within the scope of the claimed subject matter. Other advantages and novel features may become apparent from the following detailed description when considered in conjunction with the drawings.

### DESCRIPTION OF THE DRAWINGS

The appended figures depict certain aspects and are therefore not to be considered limiting of the scope of this disclosure.

FIG. 1 depicts an example implementation of a flight plan system.

FIG. 2 is a block diagram that illustrates an example analysis component.

FIG. 3 depicts an example architecture of an unmanned aircraft.

FIG. 4 depicts an example of flying and obstacle avoidance in a dynamic environment.

FIG. 5 is a flow chart diagram of an example flight plan generation method.

FIG. 6 is a flow chart diagram of an example method for avoiding obstacles.

FIG. 7 depicts an example processing system with which aspects of the subject disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for obstacle detection and avoidance.

Unmanned aircraft, including aerial vehicles (UAVs) and urban air mobility (UAM) systems, have been increasingly prevalent in recent years, offering new capabilities and opportunities in various industries. However, operating such vehicles at low altitudes presents unique challenges compared with traditional aircraft. Unmanned aircraft are vulnerable to colliding with both static and dynamic objects in their flight path, such as temporary event structures, fallen trees, a new communication tower, balloons, cranes, kites, birds, and pedestrians. The unpredictable nature of such obstacles, combined with limited sensors on board an unmanned aircraft, makes it difficult to detect and avoid hazards promptly.

Existing collision avoidance systems for unmanned aircraft typically rely solely on onboard sensors, such as LiDAR, radar, and cameras, to detect obstacles in the vicinity. However, these systems have limited capabilities to detect and avoid obstacles, especially in dynamic environments, and often require manual intervention. Regarding obstacle detection, sensors have a limited field of view, resulting in restricted detection ranges and blind spots. Further, the sensors can be affected by adverse weather conditions (e.g., precipitation, fog), which reduces visibility and accuracy. As per obstacle avoidance, a delayed reaction time is associated with acquiring and processing real-time data, which may not allow sufficient time for effective avoidance. Furthermore, onboard processing power is limited, and real-time data processing is computationally expensive, which can slow down decision-making. Furthermore, as the number of unmanned aircraft continues to grow, the likelihood of collisions rises accordingly.

Aspects disclosed herein pertain to enabling autonomous and adaptive flight planning for unmanned aircraft in dynamic environments, utilizing a ground-based computing device or a network-accessible service (e.g., cloud computing) that executes on one or more computing devices. In accordance with one aspect, the service can generate a polygon to capture a source-to-destination region, and data is fetched from one or more databases relevant to the region (e.g., weather, obstacles, terrain). Based on the data, the service can generate multiple candidate flight plans. In accordance with one aspect, the candidate flight plans can be three-dimensional, for example, to enable flights in urban areas, avoiding buildings and other structures. One flight plan is selected from the multiple flight plans that is deemed best suited to route the unmanned aircraft to a destination based on a variety of factors such as flight time, obstacle avoidance, and energy efficiency. The service can transmit the flight plan to the unmanned aircraft, which can follow the plan to navigate from a source to a destination. While in flight, the unmanned aircraft may detect an unexpected obstacle with one or more onboard sensors and signal the service. The service can analyze the sensor data to determine the characteristics of obstacles, such as their dimensions, velocity, and trajectory, as well as data regarding the obstacle region from one or more databases. Furthermore, the service can generate and transmit a reformulated flight plan to the unmanned aircraft that addresses the obstacle. If the obstacle can be avoided, the unmanned aircraft can be provided with an updated flight plan, as a reformulated flight plan, that includes one or more evasive maneuvers to avoid the obstacle and continue along the original flight path. If the obstacle is unavoidable, the unmanned aircraft can be provided with a new flight plan, as a reformulated flight plan, from the current location, establishing an alternate route around the obstacle to reach the destination.

Performing operations with a ground-based network-accessible service has several potential advantages. First, the service has access to nearly unlimited processing power compared to constrained onboard systems. As a result, more advanced processing techniques can be utilized including sophisticated machine learning models and path planning computations can be performed. Further, the service has access to multiple comprehensive databases, which provide a holistic view of an operating environment that can inform flight plan generation and adaptation. The service also avoids the need for expensive hardware or software upgrades to an unmanned aircraft system and scales to accommodate an increasing number of aircraft now (e.g., fleets) and in the future. As a result, UAV navigation is intelligent, efficient, and adaptable.

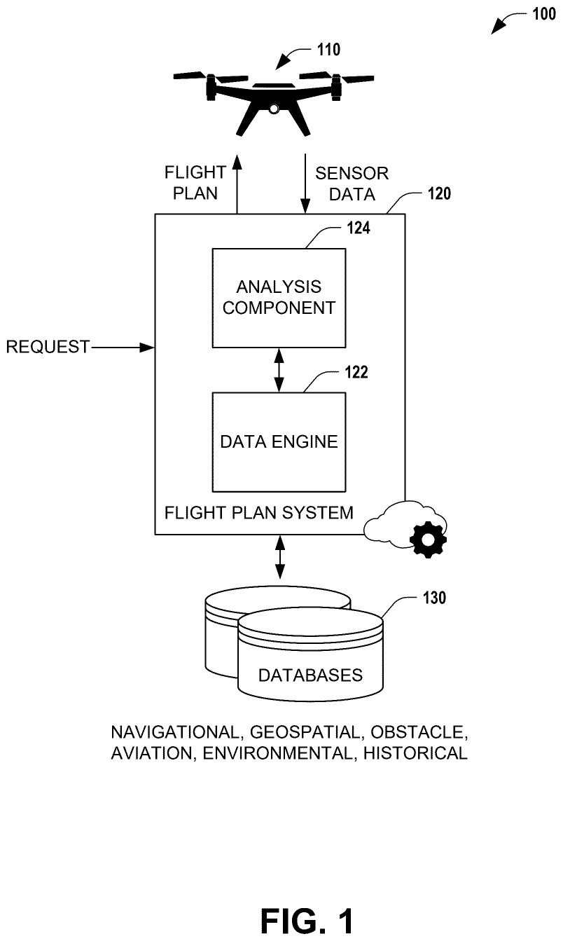

FIG. 1 depicts an example flight system implementation 100. The flight system implementation 100 includes unmanned aircraft 110, flight plan system 120, and databases 130. The unmanned aircraft 110 is communicatively coupled with flight plan system 120, and flight plan system 120 is communicatively coupled with the databases 130.

Unmanned aircraft 110 refers to any aerial vehicle that is operated without a human pilot on board, relying instead on remote control, automation, or artificial intelligence for navigation and operation. This category of vehicles encompasses a wide range of aircraft from small hobby drones to large, unmanned aerial vehicles (UAVs) used for military or commercial purposes (e.g., deliveries), inspection, aerial photography, scientific research, emergency response, and disaster recovery, among others. Unmanned aircraft can be either remotely piloted by a human operator, autonomously, or semi-autonomously, using onboard sensors and software to navigate and execute missions. Designs can range from small quadcopters to large reconnaissance aircraft. The absence of a human pilot on board allows unmanned aircraft to access areas or perform tasks that may be too dangerous, difficult, or expensive for manned aircraft.

Flight plan system 120 is configured to generate a flight plan or flight path for unmanned aircraft 110. In one instance, flight plan system 120 is configured to provide autonomous and adaptive flight planning capabilities for unmanned aircraft 110. A comprehensive set of databases 130 can be exploited for generating flight plans. Databases 130 can include information for flight planning, such as navigational data, geospatial information, obstacle details, and environmental conditions, among other things. After receiving a flight plan request identifying a destination, the flight plan system 120 can utilize data from databases 130 to generate multiple candidate flight plans for unmanned aircraft 110 to reach the destination. The flight plan system 120 can subsequently or concurrently analyze the candidate flight plans to determine the best-suited plan, considering one or more factors, such as terrain, airspace restriction, and other conditions. Further, flight plan system 120 can monitor conditions, for example, based on sensor data obtained from unmanned aircraft 110, and generate an updated flight plan or path to address the unpredictable obstacles and varying environmental factors. For example, an updated flight plan can be generated with an adjustment that performs one or more evasive maneuvers to circumvent an avoidable obstacle and continue along the original flight plan, or a new flight plan can be generated establishing an alternate route around an unavoidable obstacle. In accordance with one aspect, flight plan system 120 can be implemented as a ground-based network-accessible service (e.g., cloud service). As a result, the implementation avoids the need for expensive hardware and software upgrades to an unmanned aircraft to support new functionality. Moreover, flight plan system 120 is highly scalable to support a nearly limitless number of unmanned aircraft.

Databases 130 refer to various collections of data that flight plan system 120 utilizes to generate optimal and adaptive flight plans for unmanned aircraft 110. Databases 130 can capture various types of information related to navigation, geospatial positioning, obstacles, and environmental conditions, among other relevant factors.

What follows is a description of several databases that may comprise databases 130. A navigation database can be a worldwide or local database that includes navigational information such as airports, heliports, vertiports, runways, waypoints, procedures, and company routes. A geographic country database can include information about a location and the name of countries. A roads database includes information about roadways, highways, major roadways, and minor roadways within an area. A railway database includes information about railways in a region. An airspace database can provide air space information for various geographic areas. A geopolitical database can include information regarding political boundaries between countries, states, and provinces, as well as various other boundaries, including time zone boundaries. Further, lakes, rivers, and coastlines can also be captured in the geopolitical database. An airport database can provide information regarding an airport, including runway lengths and heliports, for example. A city database can include information regarding cities in a region. A terrain database can provide information regarding physical characteristics and features of land and geographic areas, such as elevation, canyons, cliffs, mountains, and slope and gradient of the land. An obstacle database provides information regarding various obstacles and hazards that unmanned aircraft 110 may encounter during flight, such as static obstacles (e.g., buildings, towers, power lines, bridges), dynamic obstacles (e.g., cranes, balloons, kites), obstacle dimensions, and obstacle elevation. In accordance with one aspect, obstacles detected by an unmanned aircraft can be saved in the obstacle database and utilized to generate flight plans for other unmanned aircraft. A visual reference point (VRP) database can include information regarding specific geographic locations or landmarks that can be used for navigation by the unmanned aircraft 110, for example, to orient the unmanned aircraft 110. More specifically, the VRP database can include the latitude and longitude coordinates of visual reference points, such as prominent buildings, road intersections, lakes, mountains, or coastlines. A live weather database can be continuously synchronized with live weather data, which can be overlaid on flight paths. A historical database can provide information about previously traveled flight paths, including the time taken, traffic in the path, and any obstacles that need to be avoided. An instruction set database stores information regarding a set of rules associated with different types of unmanned aircraft, such as the maximum altitude and speed at which an unmanned vehicle can fly.

Flight plan system 120 comprises data engine 122 and analysis component 124. The data engine 122 and the analysis component 124 may be implemented by at least one processor coupled to at least one memory that stores instructions that, when executed by the at least one processor, cause the at least one processor to perform the functionality of the data engine 122 and analysis component 124. Consequently, a computing device can be configured to be a special-purpose device or appliance that implements the functionality of flight plan system 120. Furthermore, all or portions of the flight plan system 120 can be distributed across multiple computing devices or made accessible through a network service (e.g., a cloud service).

Data engine 122 is configured to manage access to various databases that provide information for generating flight plans for unmanned aircraft 110. Data engine 112 provides seamless data flow and interaction with disparate data sources. In accordance with one aspect, data engine 122 can perform slicing to process data in databases 130. Slicing refers to a process of extracting a subset of data from databases 130 based on a defined polygon region.

According to one aspect, a polygon region is determined as follows. First, coordinates (e.g., latitude and longitude) of the source and destination of unmanned aircraft 110 can be obtained from a request for a flight plan. These coordinates are used to define a polygon that includes the source and destination coordinates. Next, a midpoint between the source and destination can be determined by determining the average of the latitude and longitude values. The midpoint can be treated as the center of the polygon. Using midpoint coordinates and a predefined radius or buffer distance representing the size of the desired polygon, a polygon is determined with edges defined by the buffer distance. Subsequently, the polygon can be refined to align with relevant geographic features and constraints, such as roads and airspace boundaries. Accordingly, the polygon can comprise a set of vertices and edges connecting the set of vertices that includes the latitude and longitude of the source and destination.

In accordance with one aspect, the region can be a three-dimensional shape, such as a polyhedron composed of polygonal faces. Utilizing a three-dimensional region, a more comprehensive spatial representation is provided that captures both horizontal and vertical dimensions, enabling a more complete understanding of an environment. The three-dimensional region can enable more complex route planning by accounting for various terrain features (e.g., hills, mountains, valleys, ridges, steep slopes, tree canopy) and infrastructure heights (e.g., towers, bridges, overpasses, power lines, construction sites, skyscrapers). A three-dimensional understanding of an environment enables more sophisticated flight path planning and obstacle avoidance.

Slicing performed by data engine 122 includes extracting data from databases 130 that fall within the physical boundary of the polygon region. In other words, data engine 122 can generate database queries to retrieve solely relevant data that falls within the boundaries of the polygon region. In accordance with one aspect, specific databases can be targeted that include data relevant to the polygon region, such as navigational, geospatial, and terrain databases 130. Data slicing enhances efficiency by eliminating the need to process irrelevant data outside the region of interest and reduces computational overhead by reducing the volume of data required to be stored and processed to produce a flight plan.

In addition to data slicing, data engine 122 can perform data filtering. Data filtering can apply additional criteria to sliced data to further refine and reduce the data set used for flight plan generation. For example, a filter can be applied to weather forecast data, considering solely wind and precipitation, as they significantly impact flight more than other factors, such as clear skies or moderate temperatures. Filtering can also include thresholds such that solely wind or precipitation satisfying certain thresholds, such as winds above a certain speed or heavy rain, are included in the data set. As another example, obstacles can be filtered to only include those above a particular height, focusing on the obstacles that unmanned aircraft 110 needs to avoid.

Analysis component 124 is configured to analyze data from data engine 122 and, if available, real-time sensor data from unmanned aircraft 110 and generate a flight plan from a source to a destination. In accordance with one aspect, analysis component 124 can determine possible paths and the best-suited or optimal path among them based on available data. Alternatively, a hybrid approach can be employed that seeks to determine the best-suited path directly.

In accordance with one aspect, analysis component 124 can employ one or more path finding or planning algorithms to generate a flight plan based on available data. For example, an A* search algorithm can be employed to determine a path based on a plurality of factors, such as obstacle avoidance, airspace restrictions, and weather. An A* search algorithm is a heuristic-based graph traversal and path-finding method that computes the optimal path from a start node to a goal node while avoiding obstacles. As another example, a potential field method can be employed. A potential field method is a path-planning technique that navigates toward a destination while avoiding obstacles based on virtual force fields, where attractive forces pull an object toward a goal and repulsive forces push an object away from obstacles.

In accordance with another aspect, analysis component 224 can employ one or more artificial intelligence (AI) models to determine the flight plan. For example, the AI model can correspond to a machine-learning model, which is a program or algorithm trained on data to make predictions or decisions and, here, to generate a flight plan. In one instance, the machine-learning model can be a deep neural network or combination of artificial neural networks (e.g., convolutional neural network (CNN), recurrent neural network (RNN)). A machine learning model can be trained based on historical data, including historical flight plans, sensor data, and other environment data (e.g., navigational, geospatial, obstacle, terrain, and weather). Such training data enables the machine-learning model to learn patterns and relationships between factors that influence optimal flight plan generation. During initial flight plan generation, a trained machine-learning model can be invoked using source and destination coordinates from a request, along with sliced and filtered data from data engine 122 as input. The invoked machine learning model can use its learned representation to infer or predict multiple candidate flight plans from the source to the destination. Subsequently or concurrently, multiple candidates can be evaluated to determine the optimal or best-suited flight plan, given the available data. In one instance, the machine-learning model can prioritize different objectives based on specific requirements or constraints when determining the best-suited flight plan, such as energy efficiency (e.g., fuel/battery usage), flight time, and safety and risk mitigation. In accordance with one aspect, multiple-criteria decision analysis or the like with weighted factors (e.g., fuel efficiency 25%, flight time 20%, safety 30%, weather 25%) can be employed to determine a suitability score for multiple flight plans or paths, providing a quantitative mechanism to compare and select a flight plan. A subsequent flight plan (e.g., not initial, updated, or alternate) associated with an inflight unmanned aircraft 110 can also be determined to provide collision avoidance by rerouting around an unexpected and unavoidable obstacle (described further hereinafter). In this situation, real-time sensor data from the unmanned aircraft 110, such as current location, remaining fuel/battery, and current weather, among other things, can be utilized to infer a flight plan.

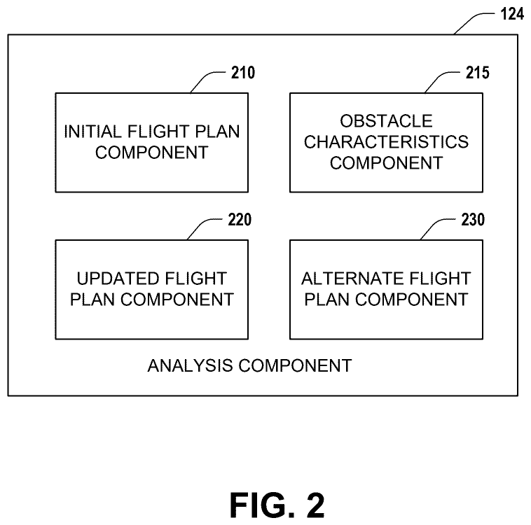

FIG. 2 depicts an example analysis component 124 in further detail. The analysis component 124 includes initial flight plan component 210, obstacle characteristics component 215, updated flight plan component 220, and alternate flight plan component 230, which may be implemented by at least one processor coupled to at least one memory that stores instructions that, when executed by the at least one processor, cause the at least one processor to perform the functionality of analysis component 124. As a result, a computing device can be configured to be a special-purpose device or appliance that implements the functionality of analysis component 124. Further, all or portions of the analysis component 124 can be distributed across computing devices or made accessible through a network service (e.g., cloud service).

Initial flight plan component 210 is configured to generate an initial flight plan from a source to a destination location. The initial flight plan component 210 takes coordinates associated with the source and destination as well as sliced and optionally filtered data from the data engine 122 and identifies a best-suited flight plan to output an initial flight plan as described above. In accordance with one aspect, a machine learning model can be trained based on historical data to generate a flight plan based on the coordinates and available data. In accordance with one aspect, the initial flight plan component 210 can account for known or predicted obstacles based on data from databases such as an obstacle database.

Obstacle characteristics component 215 is configured to determine one or more characteristics of an obstacle based on sensor data from the unmanned aircraft 110 and optionally one or more databases. In one instance, obstacle dimensions can be determined from sensor data including length, width, height, and volume. For example, point cloud measurements from a LiDAR sensor can be utilized to determine object dimensions. In another instance, multiple-sensor cross-referencing can be utilized to determine obstacle dimensions by combining spatial data from different sensors, overlaying point cloud information, determining object boundaries, and measuring object dimensions. Furthermore, one or more machine learning models can be employed to perform feature extraction or object identification. In one instance, the machine learning model can identify the specific obstacle and determine or look up the dimensions in one or more databases.

Obstacle characteristics component 215 can also determine other characteristics, such as momentum, which captures the obstacle's motion. For example, radar data can capture obstacle distance and velocity, which can be utilized alone or in combination with other sensor data (e.g., stereo camera, infrared data) to determine or estimate momentum. Further, a machine learning model can predict an obstacle's momentum based on a comparison between obstacle positions across multiple images or frames. Similar techniques can also be employed to determine the trajectory of an obstacle, for example, to determine whether the object is moving toward or away from the unmanned aircraft. Other characteristics can include current location, for example, based on radar data and GNSS location of the unmanned aircraft relative to the obstacle. The predicted future position can also be a characteristic determined based on current velocities and trajectories of obstacles.

Updated flight plan component 220 and alternative flight plan component 230 can be employed to provide collision or obstacle avoidance functionality for unmanned aircraft during flight by way of a reformulated flight plan. An obstacle can be detected based on real-time sensor data, for example, from a camera, LiDAR, and/or radar. In accordance with one aspect, obstacle detection can be performed by a computing device on unmanned aircraft 110 to prevent a collision. Subsequently, updated flight plan component 220 or alternate flight plan component 230 can be employed to provide collision avoidance based on the nature of the obstacle. In one instance, the unmanned aircraft can stop and hover momentarily while a reformulated flight plan is determined by the updated flight plan component 220 or the alternate flight plan component 230. In another instance, the processing can be performed expeditiously such that the unmanned aircraft need not stop and hover.

Updated flight plan component 220 is configured to update a flight plan in a manner that avoids an obstacle and continues with the original flight plan. In accordance with one aspect, an obstacle can be determined to be avoidable or capable of being maneuvered around without deviating substantially from the flight plan. After detecting an obstacle during flight, for example, based on onboard sensor data, information regarding object obstacle characteristics, such as the size and shape of the obstacle, can be determined based at least in part on sensor data from the unmanned aircraft. For instance, the sensor data can be produced by one or more cameras, LiDAR, or radar. Consider an example scenario in which a physical object, such as tree branches, power lines, or temporary construction structures or equipment, is detected along a flight path. In this scenario, it may be determined that making a slight vertical or horizontal deviation from the flight plan safely circumvents an obstacle. Accordingly, the original flight plan can be updated to accommodate such as a deviation, allowing for an evasive maneuver around an obstacle and continuing along the flight path set forth in the initial flight plan. In accordance with one aspect, if a safe deviation cannot be determined to maneuver around an obstacle, the obstacle can be deemed unavoidable, and alternate flight plan component 230 can be triggered to generate an alternate flight plan.

Alternate flight plan component 230 is configured to generate an alternate flight plan that reroutes unmanned aircraft 110 around an unexpected and unavoidable obstacle from the current location. In accordance with one aspect, sensor data can be analyzed to verify the presence of an obstacle and determine whether the obstacle is avoidable (e.g., capable of maneuvering around) or unavoidable (e.g., not capable of maneuvering around). After determining the obstacle is unavoidable, alternate flight plan component 220 obtains input destination coordinates, real-time sensor data from unmanned aircraft 110, including current location coordinates, and sliced and optionally filtered data from data engine 122. In accordance with one aspect, a machine learning model is trained to automatically identify an alternate flight plan after encountering an obstacle based on current location, destination, real-time data such as available fuel/battery, and sliced data.

Analysis component 124 enables generation of an initial flight plan that can avoid known obstacles and provides dynamic previously unknown obstacle evasion through an alternate flight plan for unavoidable obstacles or updated flight plan component 220 for avoidable obstacles. As a result, analysis component 124 provides safe, efficient, and adaptive navigation for unmanned aircraft 110.

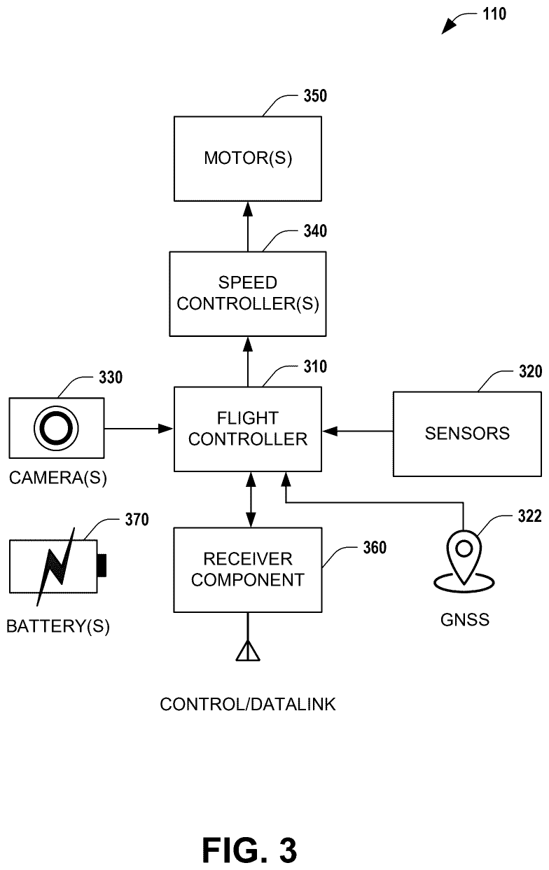

FIG. 3 depicts an example architecture of unmanned aircraft 110. The unmanned aircraft 110 includes flight controller 310, which acts as the central processing unit for the unmanned aircraft 110. The flight controller 310 is configured to manage and stabilize flight by processing sensor data and executing control commands. Furthermore, flight controller 310 can enable autonomous functions, such as navigation, altitude hold, and return-to-home. In one instance, flight controller 310 can enable autopilot functionality, which enables unmanned aircraft 110 to operate with minimal or no human input by processing sensor data and executing flight plans or paths.

Sensors 320 are configured to provide sensor data for use by the flight controller 310. Example sensors can include a gyroscope for measuring angular velocity, an accelerometer for linear acceleration, a compass for heading, an altimeter for measuring altitude, RADAR or LiDAR sensors to measure the distances of objects, an airspeed sensor form measuring airspeed, an ultrasonic sensors for detecting objects with soundwaves, infrared sensors for detecting objects based on heat signatures, time-of-flight sensors for detecting objects with light waves, and other such sensors. Other sensors identified separately are the global navigation satellite system (GNSS) receiver 322 and camera(s) 330.

GNSS receiver 322, for example, may be a global positioning system (GPS) receiver or a Galileo receiver configured to provide real-time latitude, longitude, altitude, and velocity data to flight controller 310, enabling flight controller 310 to determine the location of unmanned aircraft 110 in three-dimensional space. Further, flight controller 310 can utilize this data for autonomous navigation, facilitating movement to a specified destination by following an initial, alternate, or updated flight plan.

Camera(s) 330 can be integrated with flight controller 310 to enhance navigation, autonomous operations, and obstacle detection and avoidance. In one instance, an optical camera can produce images or video frames that can be analyzed utilizing one or more artificial-intelligence-based vision processing techniques to identify obstacles and aid navigation based on landmark identification, for example.

Speed controller(s) 340 are configured to regulate power delivered to motors 350 based on control signals from flight controller 310. Speed controller(s) 340, sometimes referred to as electronic speed controllers (ESCs), play a role in maintaining flight stability and maneuverability.

When flight controller 310 generates control signals based on pilot commands or autonomous navigation processes, the speed controller(s) 340 interpret these signals and precisely adjust the voltage and current supplied to each motor 350. By modulating the power input, the speed controller(s) 340 ensures that each motor 350 operates at the required speed and thrust level, allowing the unmanned aircraft 110 to execute flight maneuvers such as hovering, ascending, descending, and changing direction.

Motor(s) 350 are electromechanical devices that convert electric energy into mechanical motion, such as rotational motion, to generate movement of unmanned aircraft 110. In accordance with one aspect, the motor(s) 350 can be brushless DC motors, each comprising a rotating stator and a rotator driven by speed controller 340, which modulates the electric pulses to control motor speed and thrust output. In one instance, motors(s) 350 can be attached to propellers to convert rotational energy into thrust, enabling flight. By adjusting motor speeds, unmanned aircraft 110 can perform maneuvers such as hovering, ascending, descending, and directional movements with multi-rotor configurations dynamically varying thrust to maintain stability and control.

Receiver component 360 is configured to receive or obtain control signals and data and provide these control signals to flight controller 310. The receiver component 360 can receive and transmit data to and from a ground station, satellite network, remote computer system through radio frequency, wi-fi, cellular network, or satellite link. In one instance, the receiver component 360 can be employed to provide real-time flight data captured by sensors 320, such as position, altitude, and battery status to a ground-based network accessible service. For autonomous unmanned aircraft 110 the receiver component 360 works with flight controller 310 to process remote commands, execute a flight plan, and respond to obstacles with limited or no human intervention.

Battery(s) 370 is the primary power source for systems and components of unmanned aircraft 110. For example, battery(s) 370 supply energy to flight controller 310, sensors 320, camera(s) 330, speed controller(s) 340, motor(s) 350, and receiver component 360. In one instance, battery(s) 370 can correspond to a lithium-ion or lithium-polymer battery due to their high energy density and rechargeability. In accordance with one aspect, a redundant power system or solar-assisted charging system can be employed to extend the operational range of the battery(s) 370.

Components of unmanned aircraft 110 collaborate to implement flight planning system capabilities. Flight Controller 310 serves as a central processing unit that receives and executes flight plan instructions from a ground-based service. In one instance, flight controller 310 can communicate with speed controller(s) 340 to adjust motors (350) to execute a flight plan. Further, flight controller 310 can utilize location information provided by GNSS receiver 322 to aid navigation associated with flying according to a flight plan. For example, flight controller 310 can compare the current location to a flight plan location and make any necessary adjustments by communicating with the speed controller(s) 340. Sensors 320, including cameras 330, can continuously monitor the surrounding environment of the unmanned aircraft and produce sensor data for subsequent or concurrent processing. Flight controller 310 can further monitor sensor data for obstacle detection and communicate the sensor data along with other flight status information by way of the receiver component 360 to a ground-based service for subsequent or concurrent processing. After detecting an obstacle, flight controller 310 can also communicate that an obstacle has been detected and provide obstacle characteristics captured by onboard sensors 320 to the ground-based service. The ground-based service can respond through the receiver component 360 with an updated flight plan or a new flight plan for the flight controller 310 to execute, addressing the obstacle by either maneuvering around the obstacle and continuing along the original flight path or circumventing the obstacle by way of a different path. Flight controller 310 can continue to navigate to the destination, addressing any other obstacles as they are detected.

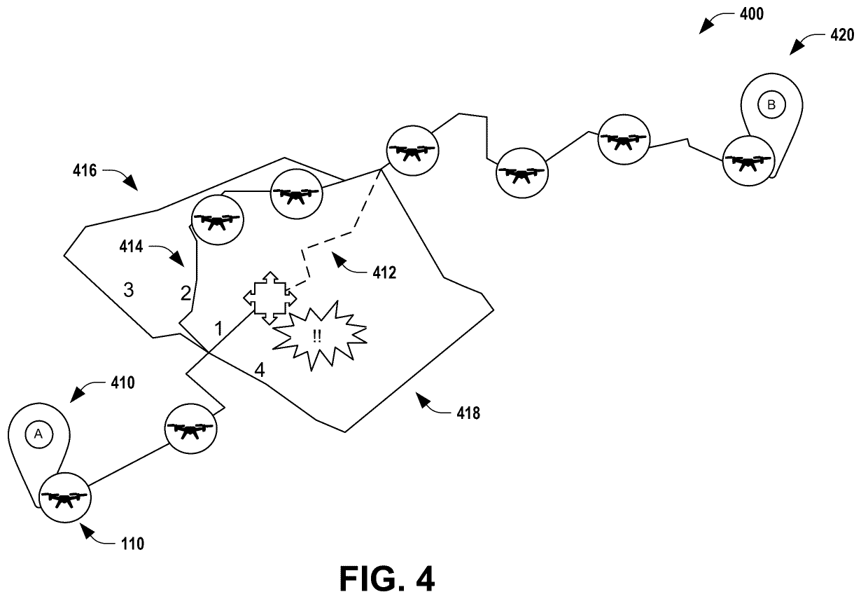

FIG. 4 depicts an example scenario 400 associated with an unmanned aircraft 110. The example pertains to flying unmanned aircraft 110 through an urban area comprising numerous high-rise buildings from origin A 410 to destination B 420. Flight plan system 120 of FIG. 1 can generate a plurality of candidate plans or paths from destination A 410 to destination B 420. Four candidate paths are identified, namely path 1 412, path 2 414, path 3 416, and path 4 418. The flight plan system 120 can evaluate the paths and identify an optimal or best-suited path, for example, based on one or more factors such as flight time, distance, safety, or a combination thereof. In example scenario 400, path 1 412 is selected as the best-suited candidate and initial flight plan. The flight plan system can then communicate the initial flight path with the unmanned aircraft. For example, receiver component 360 can obtain transmitted flight plan and communicate the initial flight plan to flight controller 310. Subsequently, the unmanned aircraft 110 starts flying from the origin 410 to the destination 420 along path 1 412 in accordance with the initial flight plan. After flying a distance, the unmanned aircraft 110 encounters an unexpected obstacle. Flight controller 310 can detect unexpected obstacles based on data from a plurality of sensors that continuously monitor the environment for potential hazards and an obstacle detection process. In accordance with one aspect, the flight controller 310 can temporarily transition the unmanned aircraft to a hovering mode after detecting an obstacle. The flight controller 310 can then notify the flight plan system 120 of the obstacle as well as real-time data regarding the object from one or more onboard sensors. The flight plan system 120, through analysis component 124, can determine a response to the unexpected obstacle. In one instance, obstacle size can be analyzed, and a determination can be made as to whether the unmanned aircraft 110 can avoid the obstacle by safely maneuvering around the object or, in other words, if the obstacle is avoidable. If the obstacle is avoidable, the flight plan system 120 can generate an updated flight plan that avoids the obstacle and continues with the initial flight plan. If the obstacle is unavoidable, the flight plan system 120 can generate an alternate plan from the current location to the destination, rerouting the unmanned aircraft 110 away from the obstacle. In some instances, an unexpected obstacle can be temporary, such as a bird or a balloon. Accordingly, flight controller 310, either alone or in conjunction with the flight plan system 120, can continuously monitor the environment to determine if the obstacle remains present. If the obstacle is no longer present, the unmanned aircraft 110 can proceed with the initial flight plan. In one instance, a final determination can be made regarding whether the obstacle is still present before updating the flight controller with a path associated with an updated or alternate flight plan.

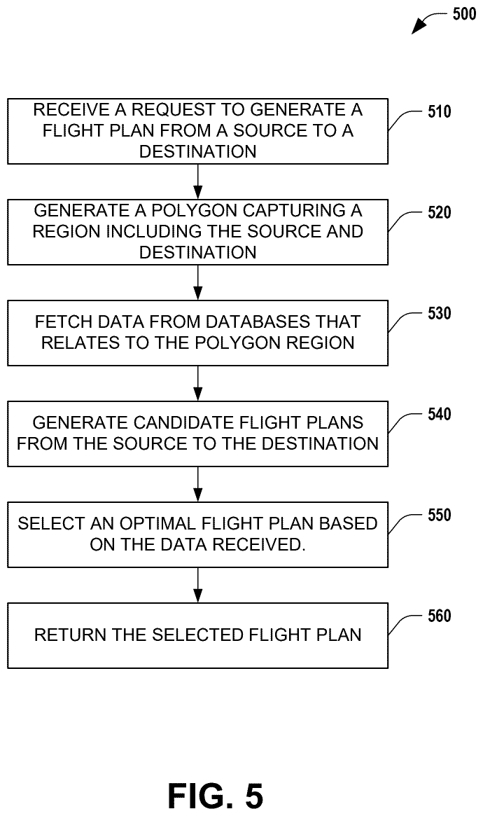

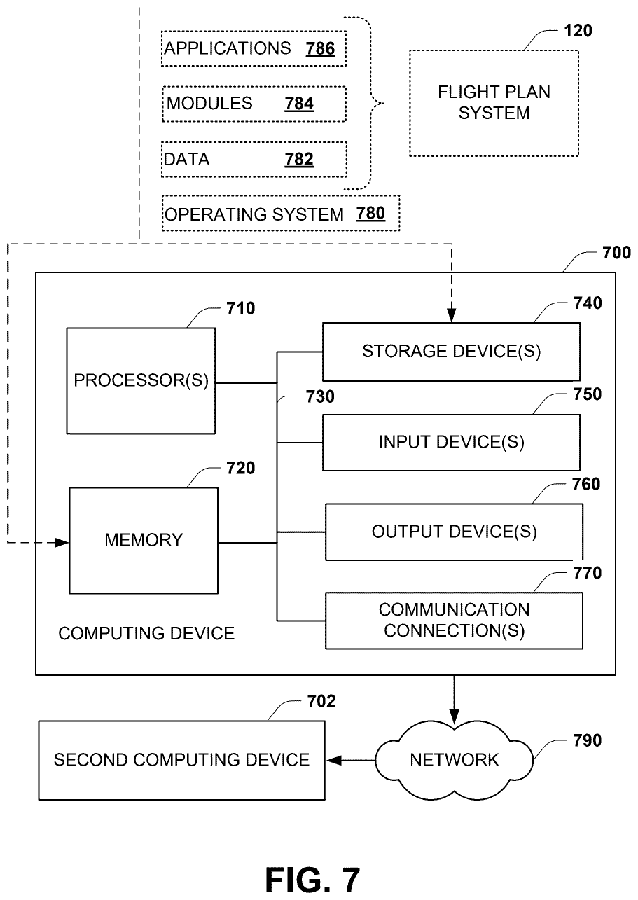

FIG. 5 illustrates an example method 500 for generating flight plans. In one aspect, method 500 can be implemented by flight plan system 120 of FIG. 1 or computing device 700 of FIG. 7. In one instance, method 500 can generate an initial flight plan from a source to a target. In another instance, the method 500 can generate an alternate flight plan that reroutes around an object.

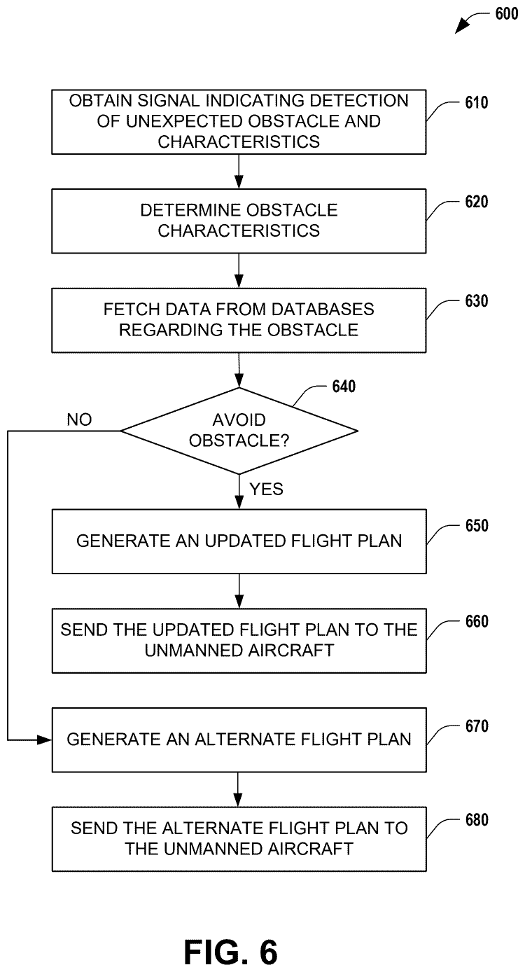

Method 500 starts at block 510 with receiving a request to generate a flight plan from a source or origin to a destination or, more specifically, source coordinates and destination coordinates (e.g., source latitude and longitude and destination latitude and longitude). A human can submit the request through a computer or a computer application or service can provide the request. For example, a package may be delivered to the destination, or an overhead image of the destination may be requested. In one instance, the method can be triggered based on detection of an unavoidable obstacle as described further in method 600 of FIG. 6

Method 500 continues at block 520 with generating a geometric object such as a polygon or polyhedron that captures a region including the source and destination as well as any waypoint between the source and destination. A polygon can capture two-dimensional space, while a polyhedron can capture three-dimensional space. In one instance, a create polygon function can be invoked or used to generate a polygon (e.g., create_polygon(src.lat, src.lon. dest.lat, dest.lon, buffer) function). In accordance with one aspect, a predefined buffer distance can be employed to generate a polygon, where the buffer distance represents the desired dimensions of the polygon. For example, a midpoint between source and destination coordinates can be determined by determining the average of latitude and longitude values. The buffer distance can be added to the midpoint coordinates to determine a square-shaped polygon around the midpoint. Further, various data sources can be employed to refine an initial polygon shape to represent the operating environment better. For example, data that can be used to refine the initial polygon can include geospatial data (e.g., roads and railways), airspace restrictions, terrain features (e.g., mountains), and known or expected obstacles. In one instance, data engine 122 of FIG. 1 can perform the functionality of block 520.

Method 500 continues at block 530 with fetching data from one or more databases that relate to the polygon region. In other words, data slices can be obtained from one or more databases based on the polygon region. In this manner, targeted data retrieval is achieved, reducing the amount of information to solely relevant information and improving efficiency and performance.

Method 500 continues at block 540 with generating candidate flight plans from the source to the destination. The candidate flight plans can be produced based at least on the data fetched from the one or more databases. In one instance, one or more pathfinding algorithms can be utilized to generate flight plans based on available data.

For example, an A* algorithm can be executed as the pathfinding algorithm to find the shortest path between a starting node (e.g., source) and a goal node (e.g., destination). The algorithm utilizes a cost function that is the sum of the cost from the start node to the current node and a heuristic estimate of the cost from the current node to the goal node, seeking to determine the lowest-cost path. Consider the following pseudocode description of an example A* algorithm that can be used to identify one or more candidate flight plans.

i. Add the starting square (or node) to the open list.

ii. Repeat the following:
Look for the lowest F cost square on the open list. //Referred to as the current square.
Switch it to the closed list.
For each of the 8 squares adjacent to this current square . . .
If it is not walkable or if it is on the closed list, ignore it. Otherwise, do the following.

If it is not on the open list, add it to the open list. Make the current square the parent of this square. Record the F, G, and H costs of the square.

If it is on the open list already, check to see if this path to that square is better, using G cost as the measure. A lower G cost means that this is a better path. If so, change the parent of the square to the current square, and recalculate the G and F scores of the square. If the list is sorted by F score, the list may need to be resorted to account for the change.

Stop when:
Add the target square to the closed list, in which case the path has been found, or
Fail to find the target square, and the open list is empty. In this case, there is no path.

iii. Save the path. Working backward from the target square, go from each square to its parent square until you reach the starting square. That is a path.

In another instance, one or more artificial intelligence (AI) models can be invoked to determine the flight plan. For example, a machine-learning model can be trained based on historical data, including historical flight plans, sensor data, and other environment data (e.g., navigational, geospatial, obstacle, terrain, and weather) and when invoked the machine learning model can infer multiple candidate flight plans from the source to the destination using its learned representation.

Method 500 continues at block 550 with selecting a flight plane from the candidate flight plans. Multiple candidates can be evaluated to determine an optimal or best-suited flight plan from the candidate flight plans. In accordance with one aspect, the best-suited flight plan can prioritize one or more objectives, such as energy efficiency (e.g., fuel/battery usage), flight time, and safety and risk mitigation. In one instance, a flight plan can be selected that minimizes flight time and safety.

In accordance with one aspect, a suitability score for flight plans or paths can be determined using a multi-criteria scoring process. For example, a plan can be scored (e.g., 0-100 points) for various factors such as fuel efficiency, flight time, obstacles, weather conditions, airspace restrictions compliance, and terrain complexity, among other considerations. Weights can be applied to the factors that assign relative importance to each factor (e.g., fuel efficiency 25%, weather 25%, flight time 20%, obstacles 30%). Next, a weighted sum can be computed to represent the suitability score. The suitability score quantifies the suitability of a flight plan, where the highest-scoring flight plan is considered the most suitable.

Method 500 continues at block 560 with returning the selected flight plan. Subsequently, the flight plan can be provided to unmanned aircraft 110, and more specifically flight controller 310, to route the unmanned aircraft 110 from a source or origin to a destination.

Method 500 of flight plan generation provides several technical benefits. For example, generating a polygon that captures a region between the source and destination creates a well-defined geographic area of interest that enable efficient and targeted data retrieval Fetching data from database based on the polygon region minimizes computational overhead and ensures solely relevant information is considered Generating multiple candidate flight plans allows for comprehensive exploration of potential paths, and selection of the best suited flight plan enables optimization for one or more factors, such as flight time, safety, and efficiency. Overall, method 500 enables automated and intelligent decision-making, improves system performance, and provides an actionable flight plan that can be employed by an unmanned aircraft, enhancing the reliability and effectiveness of autonomous flight operations

Note that FIG. 5 is just one example of a method, and other methods including fewer, additional, or alternative operations are possible consistent with this disclosure.

FIG. 6 depicts an example method 600 for avoiding obstacles. In one aspect, method 500 can be implemented by the flight plan system of FIG. 1 or computing device 700 of FIG. 7.

Method 600 begins at block 610 with obtaining a signal of a detected unexpected obstacle. An unmanned aircraft 110 flying an initial flight plan that accounts for known obstacles can detect an unknown or unexpected obstacle in a flight path. The unmanned aircraft 110 can include a variety of onboard sensors, such as LiDAR, radar, infrared cameras, and optical cameras, among others, to monitor the surrounding environment. An obstacle detection process can continuously monitor the sensor data in real-time for potential collision risks along the flight path. After an unexpected obstacle is detected, the unmanned aircraft 110 can notify or signal the flight plan system 120. In addition, data from onboard sensors regarding the obstacle can be provided to the flight plan system.

Method 600 continues at block 620 with determining obstacle characteristics. In one instance, obstacle dimensions can be determined from sensor data including length, width, height, and volume. For example, point cloud measurements from a LiDAR sensor can be utilized to determine object dimensions. In another instance, multiple-sensor cross-referencing can be utilized to determine obstacle dimensions by combining spatial data from different sensors, overlaying point cloud information, determining object boundaries, and measuring object dimensions. Furthermore, one or more machine learning models can be employed to perform feature extraction or object identification. In one instance, the machine learning model can identify the specific obstacle and determine or look up the dimensions. Other obstacle characteristics can also be determined, such as momentum, which captures the obstacle's motion. For example, radar data can capture obstacle distance and velocity, which can be utilized alone or in combination with other sensor data (e.g., stereo camera, infrared data) to determine or estimate momentum. Further, a machine learning model can predict an obstacle's momentum based on a comparison between obstacle positions across multiple images or frames. Similar techniques can also be employed to determine the trajectory of an obstacle, for example, to determine whether the object is moving toward or away from the unmanned aircraft. Other characteristics can include current location, for example, based on radar data and GNSS location of the unmanned aircraft relative to the obstacle. The predicted future position can also be a characteristic determined based on current velocities and trajectories of obstacles.

Method 600 continues at block 630 with fetching data from databases associated with the obstacle. For example, data can include geospatial information regarding terrain, roads, and infrastructure locations, as well as environmental data concerning current and forecasted weather conditions. Fetched data can also include additional historical information, such as obstacles and avoidance maneuvers, among other details.

Method 600 continues at block 640 with determining whether the obstacle can be avoided or, in other words, is avoidable. An obstacle is avoidable if it can be maneuvered around safely without substantially deviating from the flight plan. An obstacle is unavoidable if the object cannot be maneuvered around safely. Whether an obstacle is avoidable or unavoidable can be determined based on characteristics of the obstacle (e.g., length, width, location, trajectory, velocity) as well as data fetched data from one or more databases. For example, suppose an obstacle is small and stationary, such as scaffolding or a ladder. In that case, it may be determined that the unmanned aircraft can safely maneuver around the obstacle horizontally or vertically, and as such, the obstacle is avoidable. By contrast, if the obstacle is large and moving, such as a crane, the obstacle may be deemed unavoidable. Furthermore, information regarding an obstacle and past strategies to maneuver around it (e.g., successful and unsuccessful) by other unmanned aircraft can be consulted to determine whether the obstacle is avoidable.

In accordance with one aspect, the risk of colliding with a predicted path of an obstacle can be evaluated, and the best course of action is selected based on the current state and predictions, such as slowing down, stopping, or changing direction to avoid the obstacle. However, if a collision is detected, the obstacle can be deemed unavoidable. For example, consider the following pseudo code.

```
dynamic_collision_avoidance(uav_state, obstacles, goal)
{
  best_trajectory = None
  best_cost = collision
      for v in Obstacle_velocity(uav_state)
          {
    for w in angular_velocity_calc(uav_state)
              {
        trajectory = simulate_trajectory(uav_state, v, w)
        cost = evaluate_trajectory(trajectory, obstacles, goal)
        if (cost < best_cost)
                {
            best_trajectory = trajectory
            best_cost = cost
                }
              }
          }
  return best_trajectory
}
evaluate_trajectory(trajectory, obstacles, goal)
{
  if collides_with_obstacles(trajectory, obstacles)
          {
    return collision
  }
  distance_to_goal = compute_distance(trajectory.end_position, goal)
  return distance_to_goal
}
boolean collides_with_obstacles(trajectory, obstacles)
{
  for point in trajectory.path
          {
    if any(distance(point, obs) < safe_distance for obs in obstacles)
              {
        return True
              }
              return False
      }
}
```

Method 600 continues at block 650 with generating an updated flight plan, when the obstacle is determined to be avoidable (“YES”) at block 630. The updated flight plan can be generated by incorporating one or more avoidance maneuvers to maneuver around an obstacle and continue with the current flight plan. Maneuvers can include altering vertical position (e.g., altitude), horizontal position (e.g., left, right, forward, backward), and speed, or a combination thereof.

Method 600 continues at block 660 with sending the updated flight plan to the unmanned aircraft for execution. Optionally, method 600 can save the avoidance maneuvers associated with a particular obstacle to a database for subsequent use by other unmanned aircraft.

Method 600 continues at block 670 with generating an alternate flight plan, when the object is unavoidable (“NO”) at block 640. The alternate flight plan can correspond to a new flight plan from the current location of the unmanned aircraft 110 and the desired destination with additional information regarding the obstacle being known. As a result, the alternate flight plan can generate a path that reroutes the unmanned aircraft 110 around the obstacle. For example, the flight plan can request the unmanned aircraft backtrack and take a new route to the destination. In accordance with one aspect, the alternate flight plan can be generated similar to the original fight plan as set forth in method 500 of FIG. 5. For example, generating an alternate flight plan can involve invoking a multifactor optimization model, a machine-learning model, or a machine based on the fetched data from one or more databases.

Method 600 continues at block 680 with sending the alternate flight plan to the unmanned aircraft for execution. The alternate flight plan can then replace the current flight plan.

Method 600 can exploit a comprehensive set of databases and object detection data to rapidly generate different flight plans (e.g., updated or alternate) responsive to unexpected obstacles in a flight path. Such a data-driven process reduces the risk of collision while improving the safety and reliability of unmanned aircraft in dynamic and unpredictable environments.

Note that FIG. 6 is just one example of a method, and other methods including fewer, additional, or alternative operations are possible consistent with this disclosure.

FIG. 7 depicts an example processing system configured to perform various aspects described herein, including, for example, method 500 as described above with respect to FIG. 5.

To provide context for the disclosed subject matter, FIG. 7, as well as the following discussion, are intended to provide a brief, general description of an example processing system in which various aspects of the disclosure can be implemented. The example processing system is solely an example and is not intended to suggest any limitation on the scope of use or functionality.

FIG. 7 depicts an example computing device 700. The computing device 700 includes at least one processor(s) 710, memory(s) 720, bus 730, storage device(s) 740, input device(s) 750, output device(s) 760, and network interface(s) 770. Bus 730 communicatively couples at least the above device constituents. In the simplest form, computing device 700 includes one or more processor(s) 710 coupled to at least one memory 720, wherein the one or more processors 710 execute computer-executable instructions stored in the at least one memory 720 and retrieved from one or more storage device 740.

Bus 730 may be formed from any medium capable of transmitting a signal, such as conductive wires, conductive traces, optical waveguides, connectors, or the like. In one embodiment, bus 730 comprises a combination of conductive traces, conductive wires, connectors, and cooperate to permit the transmission of electrical data signals to components such as the processor(s) 710, memory(s) 720, storage device(s) 740, input device(s) 750, output device(s) 760, and network interface(s) 770.

Processor(s) 710 can be implemented with a general-purpose processor, a microprocessor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. Processor(s) 710 can also be implemented as a combination of computing devices, for example, a combination of a DSP and a microprocessor, a plurality of microprocessors, multi-core processors, one or more microprocessors in conjunction with a DSP core, or any other such configuration. In certain embodiments, processor(s) 710 are representative of one or more central processing units (CPUs), graphics processing unit (GPUs), tensor processing unit (TPUs), accelerators, and other processing devices.

Computing device 700 can include or otherwise interact with a variety of computer-readable media to facilitate control of computing device 700 to implement one or more aspects of the disclosed subject matter. The computer-readable media can be any available media accessible to computing device 700 and includes volatile and nonvolatile media and removable and non-removable media. Computer-readable media can comprise two distinct and mutually exclusive types: storage media and communication media.

Storage media includes volatile and nonvolatile, removable, and non-removable media implemented in any method or technology to store information, such as computer-readable instructions, data structures, program modules, or other data. Storage media includes memory devices (e.g., random access memory (RAM), read-only memory (ROM), electrically erasable programmable read-only memory (EEPROM)), magnetic storage devices (e.g., hard disk, floppy disk, cassettes, tape), optical disks (e.g., compact disk (CD), digital versatile disk (DVD)), and solid-state devices (e.g., solid-state drive (SSD), flash memory drive (e.g., card, stick, key drive)), or any other like mediums that store, as opposed to transmit or communicate, the desired information accessible by computing device 700. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

Memory(s) 720 and storage device(s) 740 are examples of computer-readable storage media. Depending on the configuration and type of computing device, memory(s) 720 can be volatile (e.g., random access memory (RAM)), nonvolatile (e.g., read-only memory (ROM), flash memory . . . ), or some combination of the two. By way of example, the basic input/output system (BIOS), including basic routines to transfer information between elements within the computing device 700, such as during start-up, can be stored in nonvolatile memory. By contrast, volatile memory can act as external cache memory to facilitate processing by the processor(s) 710.

The storage device(s) 740 include removable/non-removable, volatile/nonvolatile storage media for storing vast amounts of data relative to the memory(s) 720. For example, storage device(s) 740 include, but are not limited to, one or more devices such as a magnetic or optical disk drive, floppy disk drive, flash memory, solid-state drive, or memory stick.

Memory(s) 720 and storage device(s) 940 can include or have stored therein operating system 780, one or more applications 786, one or more program modules 784, and data 782. Operating system 780 can control and allocate resources of the computing device 700. Applications 787 include one or both of system and application software and can exploit management of resources by the operating system 780 through program modules 784 and data 782 stored in memory(s) 720, storage device(s) 740, or both to perform one or more actions. Accordingly, applications 786 can turn a general-purpose computer into a specialized machine according to the logic provided.

Input device(s) 750 and output device(s) 760 can be communicatively coupled to the computing device 700. By way of example, input device(s) 750 can include a pointing device (e.g., mouse, trackball, stylus, pen, touchpad), keyboard, joystick, microphone, voice user interface system, camera, sensor, and a GNSS receiver and transmitter, among other things. Output device(s) 760 can correspond to a display device (e.g., liquid crystal display (LCD), light emitting diode (LED), plasma, organic light-emitting diode display (OLED), speakers, voice user interface system, printer, and vibration motor, among other things. The input device(s) 750 and output device(s) 760 can be connected to the computing device 700 by way of a wired connection (e.g., bus), wireless connection (e.g., Wi-Fi, Bluetooth), or a combination thereof.

Computing device 700 can also include a network interface(s) 770 to enable communication with at least a second computing device 702 utilizing a network 790. Network interface(s) 770 can include wired or wireless communication mechanisms to support network communication. The network 790 can correspond to a personal area network (PAN), local area network (LAN), or a wide area network (WAN), such as the Internet. In one instance, the computing device 700 can correspond to a network-connected or cloud server executing the flight plan system 120 (FIG. 1). The second computing device 702 can correspond to or implement flight controller 310 (FIG. 3) that interacts with the computing device 700. For instance, the flight plan system 120, executing the computing device 700, can generate an initial flight plan from a source to a destination and transmit the flight plan to flight controller 310, executing on second computing device 702 through the network 790. Further, computing device 700 and second computing device 702 can interact and exchange information such as sensor data, an indication of an obstacle, and an updated or new flight plan that overcomes the obstacle.

As described herein, the functional blocks, flowchart elements, or both may be translated into machine-readable instructions. As non-limiting examples, the machine-readable instructions may be written using any programming protocol, such as: descriptive text to be parsed (e.g., such as hypertext markup language, extensible markup language,), (ii) assembly language, (iii) object code generated from source code by a compiler, (iv) source code written using syntax from any suitable programming language for execution by an interpreter, (v) source code for compilation and execution by a just-in-time compiler. Alternatively, the machine-readable instructions may be written in a hardware description language (HDL), such as logic implemented by way of either a field programmable gate array (FPGA) configuration or an application-specific integrated circuit (ASIC) or their equivalents. Accordingly, the functionality described herein may be implemented in any conventional computer programming language, as pre-programmed hardware elements, or as a combination of hardware and software components.

Note that FIG. 7 is just one example of a processing system consistent with aspects described herein, and other processing systems having additional, alternative, or fewer components are possible consistent with this disclosure.

Implementation examples are described in the following numbered clauses:
Clause 1: A method for generating flight plans, the method comprising: obtaining a request for a flight plan for an unmanned aircraft from a source to a destination; generating a polygon capturing a region comprising the source and the destination, wherein the polygon comprises a set of vertices including a latitude and a longitude of the source, a latitude and a longitude of the destination, and edges that connect the set of vertices; fetching data from one or more databases that relate to the region of the polygon; generating a plurality of candidate flight plans from the source to the destination; identifying a select flight plan from the plurality of candidate flight plans based on the data fetched from the one or more databases; transmitting the select flight plan to the unmanned aircraft; and obtaining a signal during flight of the unmanned aircraft indicating detection of an unexpected obstacle associated with the flight plan; and determining a reformulated flight plan with a different flight path that addresses the unexpected obstacle; and transmitting the reformulated flight plan to the unmanned aircraft.
Clause 2: The method of Clause 1, further comprising obtaining data from onboard sensors regarding the obstacle; determining one or more characteristics of the obstacle based on the data; and determining the reformulated flight plan based on the one or more characteristics of the obstacle.
Clause 3: The method of Clauses 1-2, wherein the obstacle is a dynamic obstacle and the one or more characteristics comprise velocity and trajectory.
Clause 4: The method of Clauses 1-3, further comprising: determining that the obstacle is unavoidable based on the one or more characteristics of the obstacle and the fetched data from the one or more databases; and generating an alternate flight plan, as the reformulated flight plan, from a current location of the unmanned aircraft to the destination.
Clause 5: The method of Clauses 1-4, further comprising: determining that the obstacle is avoidable based on the one or more characteristics of the obstacle and the fetched data from the one or more databases; and updating the selected flight plan, as the reformulated flight plan, to maneuver around the obstacle before continuing with the selected flight plan to the destination.
Clause 6: The method of Clauses 1-5, wherein identifying the select flight plan comprises invoking a multifactor optimization model based on the data fetched from the one or more databases.
Clause 7: The method of Clauses 1-6, further comprising: receiving data from the unmanned aerial vehicle during flight; and saving the data to at least one of the one or more databases
Clause 8: The method of Clauses 1-7, further comprising: receiving data from the unmanned aircraft during flight regarding one or more obstacles; and saving the data to at least one of the one or more databases.
Clause 9: The method of Clauses 1-8, wherein the select flight plan is identified based on obstacles encountered by one or more other unmanned aerial vehicles.
Clause 10: The method of Clauses 1-9, wherein generating the polygon comprises determining a midpoint between the source and destination; and generating the region based on a predefined buffer distance from the midpoint that encompasses both the source and destination.
Clause 11: A processing system, comprising: a memory comprising computer-executable instructions; and a processor configured to execute the computer-executable instructions and cause the processing system to perform a method in accordance with any one of Clauses 1-10.

Clause 12: A processing system, comprising means for performing a method in accordance with any one of Clauses 1-10.

Clause 13: A non-transitory computer-readable medium storing program code for causing a processing system to perform the steps of any one of Clauses 1-10.

Clause 14: A computer program product embodied on a computer-readable storage medium comprising code for performing a method in accordance with any one of Clauses 1-10.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “real-time” can encompass immediate processing with minimal or no delay or processing with a slight delay introduced by automated data processing or network transmission, sometimes referred to as near real-time.

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating flight plans, the method comprising:
obtaining a request for a flight plan for an unmanned aircraft from a source to a destination;
generating a polygon capturing a region comprising the source and the destination, wherein the polygon comprises a set of vertices including a latitude and a longitude of the source, a latitude and a longitude of the destination, and edges that connect the set of vertices;
fetching data from one or more databases that relate to the region of the polygon;
generating a plurality of candidate flight plans from the source to the destination;
identifying a select flight plan from the plurality of candidate flight plans based on the data fetched from the one or more databases;
transmitting the select flight plan to the unmanned aircraft; and
obtaining a signal during flight of the unmanned aircraft indicating detection of an unexpected obstacle associated with the flight plan; and
determining a reformulated flight plan with a different flight path that addresses the unexpected obstacle; and
transmitting the reformulated flight plan to the unmanned aircraft.

2. The method of claim 1, further comprising:
obtaining data from onboard sensors regarding the obstacle;
determining one or more characteristics of the obstacle based on the data; and
determining the reformulated flight plan based on the one or more characteristics of the obstacle.

3. The method of claim 2, wherein the obstacle is a dynamic obstacle and the one or more characteristics comprise velocity and trajectory.

4. The method of claim 2, further comprising:
determining that the obstacle is unavoidable based on the one or more characteristics of the obstacle and the fetched data from the one or more databases; and
generating an alternate flight plan, as the reformulated flight plan, from a current location of the unmanned aircraft to the destination.

5. The method of claim 2, further comprising:
determining that the obstacle is avoidable based on the one or more characteristics of the obstacle and the fetched data from the one or more databases; and
updating the selected flight plan, as the reformulated flight plan, to maneuver around the obstacle before continuing with the selected flight plan to the destination.

6. The method of claim 1, wherein identifying the select flight plan comprises invoking a least one machine learning model trained to identify the select flight plan based on the fetched data from the one or more databases.

7. The method of claim 1, wherein identifying the select flight plan comprises invoking a multifactor optimization model based on the data fetched from the one or more databases.

8. The method of claim 1, further comprising:
receiving data from the unmanned aircraft during flight regarding one or more obstacles; and
saving the data to at least one of the one or more databases.

9. The method of claim 8, wherein the select flight plan is identified based on obstacles encountered by one or more other unmanned aerial vehicles.

10. The method of claim 1, wherein generating the polygon comprises:
determining a midpoint between the source and destination; and
generating the region based on a predefined buffer distance from the midpoint that encompasses both the source and destination.

11. A system, comprising:
at least one processor implemented in circuitry;
at least one memory coupled to the at least one processor that stores instructions that, when executed by the at least one processor, cause the system to:
obtain a request for a flight plan for an unmanned aircraft from a source to a destination;
generate a polygon capturing a region comprising the source and the destination, wherein the polygon comprises a set of vertices including a latitude and a longitude of the source, a latitude and a longitude of the destination, and edges that connect the set of vertices;
fetch data from one or more databases that relate to the region of the polygon;
generate a plurality of candidate flight plans from the source to the destination;
identify a select flight plan from the plurality of candidate flight plans based on the data fetched from the one or more databases;
transmit the select flight plan to the unmanned aircraft;
obtain a signal during flight of the unmanned aircraft indicating detection of an unexpected obstacle associated with the flight plan;
determine a reformulated flight plan with a different flight path that addresses the unexpected obstacle; and
transmit the reformulated flight plan to the unmanned aircraft.

12. The system of claim 11, wherein the instructions further cause the system to:
obtain data from onboard sensors regarding the obstacle;
determine one or more characteristics of the obstacle based on the data; and
determine the reformulated flight plan based on the one or more characteristics of the obstacle.

13. The system of claim 12, wherein the obstacle is a dynamic obstacle and the one or more characteristics comprise velocity and trajectory.

14. The system of claim 12, wherein the instructions further cause the system to:
determine that the obstacle is unavoidable based on the one or more characteristics of the obstacle and fetched data from the one or more databases; and
generate an alternate flight plan, as the reformulated flight plan, from a current location of the unmanned aircraft to the destination.

15. The system of claim 12, wherein the instructions further cause the system to:
determine that the obstacle is avoidable based on the one or more characteristics of the obstacle and fetched data from the one or more databases; and
update the selected flight plan, as the reformulated flight plan, to maneuver around the obstacle before continuing with the selected flight plan to the destination.

16. The system of claim 11, wherein to identify the select flight plan the instructions further cause the system to invoke at least one machine learning model trained to identify the select flight plan based on the fetched data from the one or more databases.

17. The system of claim 11, wherein to identify the select flight plan the instructions further cause the system to invoke a multifactor optimization model based on the fetched data from the one or more databases.

18. The system of claim 11, wherein the select flight plan is identified based on obstacles encountered by one or more other unmanned aerial vehicles.

19. A computer-readable storage medium having instructions stored thereon that, when executed, cause one or more processors to:
obtain a request for a flight plan for an unmanned aircraft from a source to a destination;
generate a polygon capturing a region comprising the source and destination, wherein the polygon comprises a set of vertices including latitude and longitude of the source and destination and edges connecting the set of vertices;
fetch data from one or more databases that relate to the region of the polygon;
generate a plurality of candidate flight plans from the source to the destination;
identify a select flight plan from the plurality of candidate flight plans based on the data fetched from the one or more databases; and
transmit the select flight plan to the unmanned aircraft;
obtain a signal during flight of the unmanned aircraft indicating detection of an unexpected obstacle associated with the flight plan;
determine a reformulated flight plan with a different flight path that addresses the unexpected obstacle; and
transmit the reformulated flight plan to the unmanned aircraft.

20. The computer-readable storage medium of claim 19, wherein the instructions further cause the one or more processors to:
obtain data from onboard sensors regarding the obstacle;
determine one or more characteristics of the obstacle based on the data; and
determine the reformulated flight plan based on the one or more characteristics of the obstacle and data from the one or more databases.
